(19) United States
(12) Patent Application Publication
(10) Pub. No.: US 2024/0322203 A1
(43) Pub. Date: Sep. 26, 2024

(54) METHOD FOR OPERATING A FUEL CELL SYSTEM, AND CONTROL DEVICE

(71) Applicant: Robert Bosch GmbH, Stuttgart (DE)

(72) Inventors: Timo Bosch, Renningen (DE); Tobias Falkenau, Esslingen (DE)

(21) Appl. No.: 18/547,094

(22) PCT Filed: Mar. 31, 2022
(86) PCT No.: PCT/EP2022/058593

§ 371 Date: Aug. 18, 2023

(30) Foreign Application Priority Data
Apr. 28, 2021 (DE) 10 2021 204 210.4

(51) Int. Cl. H01M 8/0432; H01M 8/04119; H01M 8/04492; H01M 8/04746

(52) U.S. Cl. CPC H01M 8/04328; H01M 8/04164; H01M 8/045; H01M 8/04761

(57) ABSTRACT

The invention relates to a method for operating a fuel cell system comprising a fuel cell stack (1), wherein an anode gas containing fresh and recirculated hydrogen is fed to an anode (2) in the fuel cell stack (1) via an anode circuit (3), and liquid water contained in the anode gas is separated by means of a water separator (4) integrated into the anode circuit (3), is collected in a container (5), and is removed from the system by intermittently opening a drain valve (6). According to the invention, in order to detect whether the container (5) is full, the actual temperature of the anode gas in the inlet area (7) of the anode (2) in the fuel cell stack (1) is compared with a desired temperature. If the actual temperature is lower than the desired temperature, the container (5) is considered to be full and the drain valve (6) is opened.

The invention further relates to a control device for carrying out the method or individual method steps.

### BACKGROUND

The invention relates to a method for operating a fuel cell system, in particular a polymer electrolyte membrane (PEM) fuel cell system. Furthermore, the invention relates to a control device configured so as to perform steps of the method.

A PEM fuel cell comprises a polymer electrolyte membrane arranged between an anode and a cathode. Using the PEM fuel cell, hydrogen fed to the anode and oxygen fed in the form of air to the cathode can be converted into electrical energy, heat, and water. In practical application, a plurality of fuel cells is gathered together to form a fuel cell stack, also known as a “stack,” in order to increase the generated electric voltage.

Because anode gas exiting from a PEM fuel cell typically contains still unused hydrogen, it is recirculated and re-fed to the anode in a fuel cell stack. The recirculation can be realized passively with the aid of a jet pump and/or actively with the aid of a recirculation fan. Over time, however, the recirculated anode gas accumulates with nitrogen and water, wherein the water can be present in the form of water vapor and liquid water. Liquid water is usually removed using a water separator. It can be arranged as a stand-alone component in the anode circuit or can be integrated into a recirculation fan. The water separator typically comprises a container in which the separated liquid water is collected. By opening a valve, the so-called drain valve, the container can be emptied. The timepoint of the opening depends on the fill level of the container. It should be selected so that the container does not overflow. This is because, in case of overflow of the container, liquid water can enter downstream components, for example into a downstream recirculation fan.

The amount of water generated in the operation of a fuel cell system depends on various operating parameters and can vary widely. Furthermore, heat losses, for example in the shutdown event, can lead to water being condensed so that the liquid water content increases. The fill level in the container for collecting liquid water is therefore usually monitored with the aid of a fill level sensor. In mobile applications, however, the level sensor is subjected to fluctuations and/or vibrations that can affect the measurement result, such that the use of a level sensor is problematic. Moreover, the use of a fill level sensor increases costs.

### SUMMARY

The present invention therefore addresses the problem of providing a method for operating a fuel cell system that allows for a reliable and at the same time inexpensive monitoring of the fill level in a container for collecting separated water without a fill level sensor.

Advantageous further developments of the invention can be found in the subclaims. In addition, a control device for carrying out the method or individual method steps is specified.

In the proposed method for operating a fuel cell system with a fuel cell stack, an anode in the fuel cell stack is fed with an anode gas comprising fresh and recirculated hydrogen via an anode circuit. Liquid water contained in the anode gas is separated with the aid of a water separator integrated into the anode circuit, collected in a container, and removed from the system by temporarily opening a drain valve. According to the invention, in order to detect whether the container is full, the actual temperature of the anode gas in the inlet area of the anode in the fuel cell stack is compared with a desired temperature. If the actual temperature is lower than the desired temperature, the container is considered to be full and the drain valve is opened.

The method operates on the basis of the following assumptions:

Anode gas exiting the anode can have a relative humidity (rH) of 0% to supersaturated. In addition to saturated anode gas, liquid water can therefore also leak out. Liquid water is separated in the water separator and collected in the container provided for it. If there is a water separator with maximum separating efficiency, the anode gas downstream of the water separator has a relative humidity, which can be 0 to 100% in case of ideal separation. If the separation is not ideal, a liquid water content is also contained.

The relative humidity (rH) of the freshly dosed hydrogen is 0%.

Knowing the states of the two material flows, according to the lever rule, also known as the “law of opposing levers,” an adiabatic mixing temperature in the inlet area of the anode can be calculated. This value specifies the expected temperature, that is to say the desired temperature. If the actual temperature is lower than the desired temperature, this indicates a full container. This is because, with a full container, the efficiency of the water separator worsens and less liquid water is separated. This mixes with the freshly dosed hydrogen, and there is a post-vaporization of the liquid water. The adiabatic mixing temperature then drops below the mixing temperature value in case of ideal operation. From the drop in the temperature in the inlet area of the anode, it can now be concluded that the container for collecting the separated liquid water is full or has reached a maximum fill level. By opening the drain valve, the container can then be emptied.

Realizing that the container is full according to the method according to the invention does not require a fill level sensor, so that the disadvantages mentioned above are eliminated. The method can also be implemented simply and inexpensively.

Preferably, the actual temperature of the anode gas in the inlet area of the anode in the fuel cell stack is measured using a temperature sensor. By measuring the actual temperature, reliable temperature values are made available. Because the temperature is typically measured in the inlet area of the anode, a temperature sensor already existing can be used so that no additional sensor must be provided. The method can thus be implemented even more simply and cost-effectively.

Further preferably, the desired temperature is calculated in advance, wherein the composition of the anode gas is considered. The composition, i.e., the proportion of fresh hydrogen as well as the proportion of recirculated hydrogen, is assumed to be known. The pre-calculated desired temperature can be stored in a control device, with the help of which the comparison of the actual temperature with the desired temperature can then be carried out when performing the method.

Preferably, when the desired temperature is calculated, all operations are assumed to be isobaric under constant operating conditions.

Furthermore, it is proposed that a plausibility test be performed prior to opening the drain valve. In this way, an unnecessary opening of the drain valve can be prevented when the container is not full. In the plausibility test, it is preferably checked whether falling below the desired temperature can be attributed to at least one other factor influencing the temperature of the anode gas in the inlet area of the anode, for example the external temperature. The time elapsed since the last opening of the drain valve can also be used for the plausibility test.

Alternatively or in addition, it is proposed that a plausibility test be performed after the drain valve closes. After closing, the actual temperature should be approximately the desired temperature, because the container has been emptied. If this is not the case, this can be seen as an indication that the temperature decrease is not due to a full container. In order to perform the plausibility test, the current actual temperature of the anode gas in the inlet area of the anode is preferably measured and compared to the actual temperature before opening the drain valve.

Advantageously, the actual temperature is used in order to infer the relative humidity of the anode gas in the inlet area of the anode. The method can thus also be used in order to control the moisture. If necessary, measures for moisture control can then be initiated. For example, the anode gas can be heated. Alternatively or in addition, an operating point change can be made.

In addition, a control device that is configured so as to perform steps of the method according to the invention is proposed. In particular, the comparison of the actual temperature with the desired temperature can be carried out with the aid of the control device. The control device preferably stores at least one desired temperature for this purpose. Preferably, a plurality of desired temperatures for different anode gas compositions and/or operating points are stored. If a full container is detected, the control device can be used in order to actuate and open the drain valve so as to empty the container.

### BRIEF DESCRIPTION OF THE FIGURES

The invention and its advantages will be explained in further detail in the following with reference to the accompanying drawings. The figures show:

FIG. 1 a schematic illustration of an anode circuit of a fuel cell system with an integrated water separator; and

FIG. 2 a diagram for graphing the temperature progression over time.

### DETAILED DESCRIPTION

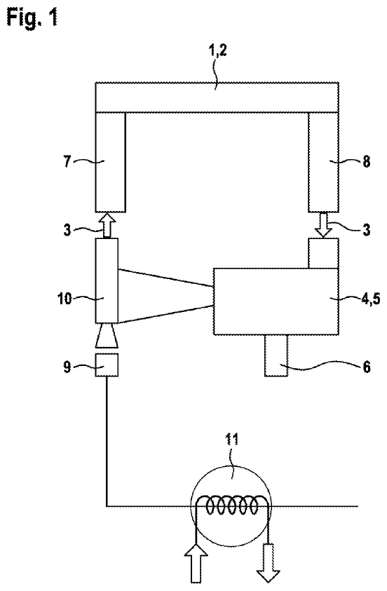

FIG. 1 shows an anode circuit 3 of a fuel cell system having a fuel cell stack 1. Via the anode circuit 3, an anode 2 in the fuel cell stack 1 is fed with an anode gas comprising fresh hydrogen as well as recirculated hydrogen. The anode gas is fed to the anode 2 via an inlet area 7. Depleted anode gas exiting the anode 2 via an exit area 8 is recirculated via the anode circuit 3. The recirculation is effected with the aid of a jet pump 10, which uses fresh hydrogen as the propellant medium.

The fresh hydrogen is stored in a tank (not shown) under high pressure and dosed into the anode circuit 3 using a dosing valve 9. Prior to dosing into the anode circuit 3, the pressure and/or temperature must be brought to a suitable level. For example, a heat exchanger 11 can be provided for the temperature control of the hydrogen.

The anode gas exiting the outlet area 8 is fed to a water separator 4 integrated

upstream of the jet pump 10 in the anode circuit 3, because the exiting anode gas contains not only water vapor but also water in liquid form. Liquid water is separated via the water separator 4 so that, ideally, the recirculated anode gas no longer contains liquid water. The water separated using the water separator 4 is collected in a container 5, which in the present case is integrated into the water separator 4. With a full container 5, a drain valve 6 arranged on the container 5 can be opened and the container 5 emptied.

In order to detect whether the container 5 is full, according to the present invention, the actual temperature in the inlet area 7 of the anode 2 can be measured and compared with a desired temperature. Because the actual temperature decreases under constant system operating conditions, a full container 5 can be assumed. In that case, drain valve 6 should be opened and container 5 emptied. The actual temperature should then rise again. By a new measurement of the actual temperature, a plausibility test can accordingly be carried out.

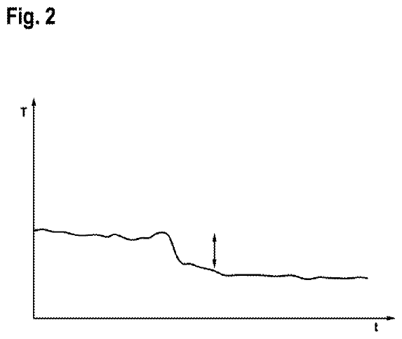

In FIG. 2, the progression of the actual temperature T in the inlet area 7 of an anode 2 over time t is illustrated as an example. The significant decrease in temperature (see arrow) indicates a full container 5. This is because, with a full container, the efficiency of the water separator 4 worsens so that the moisture of the anode gas increases in the inlet area 7. At the same time, the adiabatic mixing temperature drops below the value of the mixing temperature in case of ideal water separation.

The method can further be used in order to detect the entry conditions with respect to relative humidity of the anode gas and to initiate systemic measures, as needed.

1. A method for operating a fuel cell system that includes a fuel cell stack (1), wherein an anode gas containing fresh and recirculated hydrogen is fed to an anode (2) in the fuel cell stack (1) via an anode circuit (3), and liquid water contained in the anode gas is separated by means of a water separator (4) integrated into the anode circuit (3), is collected in a container (5), and is removed from the system by intermittently opening a drain valve (6), the method comprising:
comparing, in order to detect whether the container (5) is full, an actual temperature of the anode gas in the inlet area (7) of the anode (2) in the fuel cell stack (1) to a desired temperature, and,
when the actual temperature is lower than the desired temperature, determining the container (5) to be full and opening the drain valve (6).

2. The method according to claim 1, wherein the actual temperature of the anode gas in the inlet area of the anode (2) in the fuel cell stack (1) is measured using a temperature sensor.

3. The method according to claim 1, wherein, the desired temperature is calculated in advance, wherein the composition of the anode gas is considered.

4. The method according to claim 3, wherein, when the desired temperature is calculated, all operations are assumed to be isobaric under constant operating conditions.

5. The method according to claim 1,
wherein, prior to opening the drain valve (6), a plausibility test is carried out, wherein it is preferably checked whether falling below the desired temperature can be attributed to at least one other factor influencing the temperature of the anode gas in the inlet area (7) of the anode (2).

6. The method according to claim 1,
wherein, after closing the drain valve (6), a plausibility test is carried out, wherein preferably the current actual temperature of the anode gas in the inlet area (7) of the anode (2) is measured and compared to the actual temperature before opening the drain valve (6).

7. The method according to claim 1,
wherein the actual temperature is used to infer the relative humidity of the anode gas in the inlet area of the anode and measures for moisture control are initiated.

8. A control unit for operating a fuel system that includes a fuel cell stack (1), wherein an anode gas containing fresh and recirculated hydrogen is fed to an anode (2) in the fuel cell stack (1) via an anode circuit (3), and liquid water contained in the anode gas is separated by means of a water separator (4) integrated into the anode circuit (3), is collected in a container (5), and is removed from the system by intermittently opening a drain valve (6), wherein the control unit is configured to:
compare an actual temperature of the anode gas in the inlet area (7) of the anode (2) in the fuel cell stack (1) to a desired temperature, and,
when the actual temperature is lower than the desired temperature, open the drain valve (6).
